(19) United States
(12) Patent Application Publication
(10) Pub. No.: US 2007/0134365 A1
(43) Pub. Date: Jun. 14, 2007

(54) WATER-COOLED CONTROL DEVICE FOR A PLASTICS PROCESSING MACHINE

(75) Inventor: Gunther Grimm, Hilgertshausen (DE)

Correspondence Address: Henry M. Feiereisen;Henry M. Feiereisen, LLC, Suite 4714, 350 Fifth Avenue, New York, NY, 10118, US

(73) Assignee: Krauss-Maffei Kunststofftechnik GmbH, Munchen (DE)

(21) Appl. No.: 11/538,197

(22) Filed: Oct. 3, 2006

Related U.S. Application Data
(63) Continuation of application No. PCT/EP04/03572, filed on Apr. 3, 2004.

(51) Int. Cl. B29C 45/00

(52) U.S. Cl. 425/547

(57) ABSTRACT

A control device for use with a plastics processing machine, e.g. an injection molding machine, includes a housing which is constructed for protection against ingress of water in compliance with the IP code and accommodates a heat source such as a CPU unit or a display unit. A cooling system is provided for dissipating heat generated by the heat source and includes a pump for pumping a coolant, at least one cooling element arranged inside the housing, a cooler provided outside the housing, and a coolant circuit for circulation of the coolant. The coolant circuit fluidly connects hereby the pump, the cooling element and the cooler with one another.

### CROSS-REFERENCES TO RELATED APPLICATIONS

This application is a continuation of prior filed copending PCT International application no. PCT/EP2004/003572, filed Apr. 3, 2004, which designated the United States and on which priority is claimed under 35 U.S.C. §120.

### BACKGROUND OF THE INVENTION

The present invention relates, in general, to a control device, in particular for application in a plastics processing machine, such as an injection molding machine or extruder.

Nothing in the following discussion of the state of the art is to be construed as an admission of prior art.

A control device for a machine tool or a plastics processing machine, such as an injection molding machine for producing a plastic article, generally includes a CPU unit, a power supply for voltage regulation and a display unit for visualizing operating data of the injection molding machine. For protection from damaging environmental influences, these components of the control device are accommodated in a housing which must satisfy certain, standardized protection classes and housing protection codes. Typically, the control device has to be accommodated in a housing which is protected from spray water, for example in an operator terminal or in a switch cabinet that satisfies the IP protection code IP X4, i.e. water-resistant to meet this standard (IP-Code for protection from touching, foreign bodies and water for electrical equipments according to European standard EN 60529 and DIN VDE 0470-1).

To comply with the aforementioned IP codes, heat generated by the control device within the housing has been distributed to date with the assistance of fans and dissipated through convection to the outside. A sufficient temperature difference between the internal and external temperatures is needed for providing an effective convection. Installation of fans in the housing wall for conducting heat from inside the housing to the outside is however difficult to reconcile with a compliance of the aforementioned codes.

It would therefore be desirable and advantageous to provide an improved control device for an injection molding machine to obviate prior art shortcomings and to ensure a dissipation of loss heat of an electronic control using in a housing, regardless of ambient temperature while still complying with housing protection codes.

### SUMMARY OF THE INVENTION

According to one aspect of the present invention, a plastics processing machine for making a plastic article includes a control device for controlling the plastics processing machine, with the control device including a housing constructed for protection against ingress of water in compliance with IP code, a heat source arranged in the housing, and a cooling system for dissipating heat generated by the heat source, wherein the cooling system includes a pump for pumping a coolant, at least one cooling element arranged inside the housing, a cooler provided outside the housing, and a coolant circuit for circulation of the coolant, with the coolant circuit fluidly connecting the pump, the cooling element and the cooler with one another.

A control device according to the invention, e.g. for use in an injection molding machine, provides reliable dissipation of heat generated by electronic control components inside a housing, independent of the ambient temperature and in compliance with protective housing codes for control systems of injection molding machines. The separation of pump and cooler enables a disposition of the cooler outside the housing of the control system, without requiring the pump to be moved outside. Furthermore, it is not necessarily required to arrange the at least one cooling element (cooling plate) upon a component of the control system. Although such a configuration may be desired, the fact remains that the cooling element can be placed anywhere inside the housing. Optionally, one or more additional cooling plates may be provided inside the housing for placement upon the components of the cooling system and connected to the coolant circuit.

The use of a cooler with fan allows also to achieve a greater cooling capacity so as to ensure sufficient cooling action even when the difference between the internal and external temperatures is small.

A display unit which also produces a certain heat output is typically provided either outside of, or integrated into, the housing of a control device of an injection molding machine. Suitably, a separate cooling plate may be attached upon the display unit.

According to another feature of the present invention, the control device may be accommodated in a switch cabinet, and only an operator terminal with a display unit and a keyboard may be provided on the injection molding machine, whereby the operator terminal includes electronic components which produce only little heat. In this case, the CPU for the injection molding machine control device is located in the switch cabinet and the coolant circuit is integrated in the water-resistant switch cabinet. Optionally, a separate coolant circuit may be provided for the separate operator terminal. If need be, the control device in the switch cabinet and the separate operator terminal may be connected to a common coolant circuit.

According to another feature of the present invention, an equalizer reservoir may be provided for the coolant and placed outside the housing, in particular separate from the cooler.

A flowmeter in the coolant circuit may be provided to monitor the cooling system for operativeness. A possible malfunction of the cooling system can be detected through generation of an electrical signal and through monitoring of the electric signal. The pump can be constructed as a variable-capacity pump to suit different cooling needs. The adjustment of the pump can be carried out in various ways. For example, it is possible to determine the temperature of the coolant and to control the pump in response to the temperature.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of an exemplary injection molding machine provided with one embodiment of a control device according to the invention;

FIG. 2 is a schematic block diagram of a coolant circuit of the control device for the injection molding machine of FIG. 1; and

FIG. 3 is a schematic illustration of an exemplary injection molding machine provided with another embodiment of a control device according to the invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

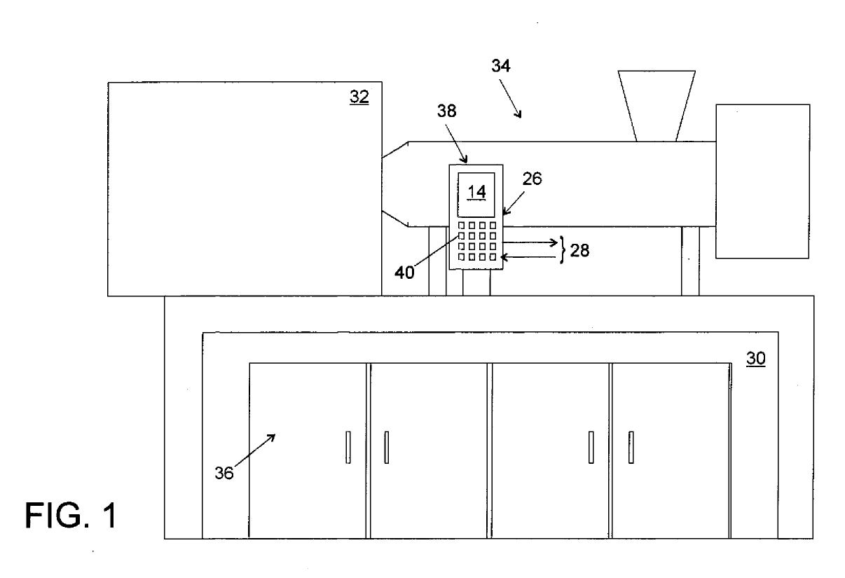

Turning now to the drawing, and in particular to FIG. 1, there is shown, by way of example of a plastics processing machine, an injection molding machine having a machine bed 30 for support of a clamping unit 32 and a plasticizing and injection unit 34. A switch cabinet 36 is located below the machine bed 30 for accommodating electrical, electronic and/or electromechanical components, for example safety fuses, relays, inverters, transformers, power supplies, controllers, etc. In addition, the injection molding machine has an operator terminal 38 which is arranged at eye level and includes a display unit 14 and a keyboard 40, for example a soft-key keyboard.

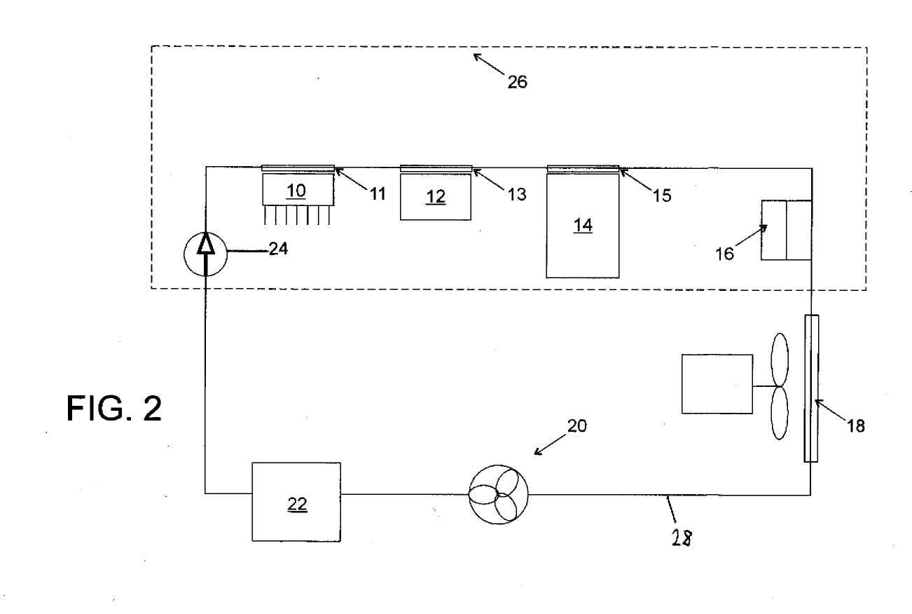

The injection molding machine of FIG. 1 has a water-cooled control device which is installed in the operator terminal 38. As shown in FIG. 2, which is a schematic block diagram of the control device in accordance with the present invention, the control device has at least a CPU unit 10 and other electronic components. If needed, a power supply can also be provided. The CPU unit 10 is shown here together with a hard disk 12 and the display unit 14 and accommodated into a housing 26 of the operator terminal 38. Of course, the housing 26 is able to accommodate further components that are not shown here for the sake of simplicity. FIG. 2 shows greatly schematically only those components of the control device that need to be cooled. For reasons of operating safety, the housing 26 has to be protected from water ingress, at least from dripping water, to comply with the IP code IP X1, preferably however protected from sprayed water according to IP code IP X4.

The control device includes a cooling system to dissipate heat generated by the heat-generating components. The cooling system includes a coolant circuit 28 (FIG. 1) which is provided in sequence with a pump 24, coolant flow plates 11, 13 and 15, an additional cooling element 16, a cooler 18 with a fan, a flowmeter 20 and an equalizer reservoir 22. Water is used as coolant and flows past the aforementioned components successively through the coolant circuit 28. The coolant flow plates 11, 13, 15 are constructed to conform to the components being cooled, i.e. the CPU unit 10, the hard disk 12, and the display unit 14, and are arranged upon a surface of the components, respectively, in a manner to provide good heat transfer. The additional cooling element 16 is arranged in the housing 26 in the absence of a direct contact to a component of the control device and is intended for cooling the interior of the housing 26.

Thus, the housing 26 of the control system accommodates the pump 24, the heat-generating components CPU unit 10, hard disk 12, display unit 14 of the control device, and the coolant flow plates 11, 13, 15 and cooling element 16. The cooler 18 with the fan is mounted outside the housing 26, as are the flowmeter 20 and the equalizer reservoir 22.

At operation of the cooling system, the coolant flow plates 11, 13, 15 directly take away heat generated by the heat-generating components 10, 12, 14, and the cooling element 16 dissipates ambient heat inside the housing 26, for transport of the heat via the coolant water and the coolant circuit 28 to the cooler 18. The output of the cooler 18 can be adjusted by means of the fan for example.

The flowmeter 20 assumes a monitoring task to check the operativeness of the cooling system. Possible failure can be detected through this supervision by generating a corresponding electrical signal.

A cooling system according to the present invention provides not only compliance with protection codes and superior cooling action even when small temperature differences are involved but also an enhanced operational safety, longer service life of the components of the control system, and a wider range of application with regard to ambient temperature.

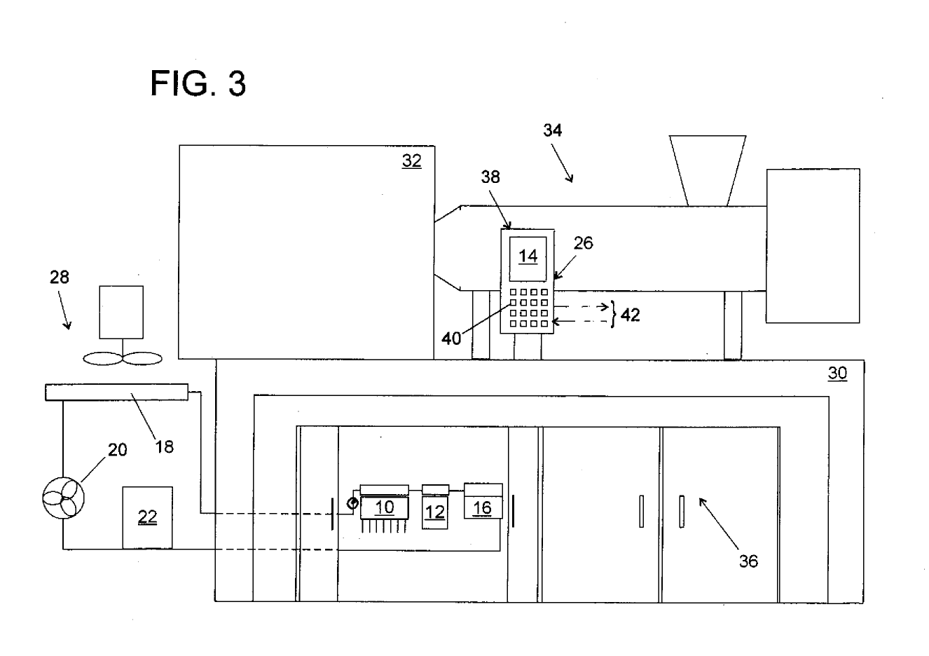

Referring now to FIG. 3, there is shown a modification of a control system according to the present invention. Parts corresponding with those in FIG. 2 are denoted by identical reference numerals and not explained again. The description below will center on the differences between the embodiments. In this embodiment, the CPU unit 10, the hard disk 12 and the additional cooling element 16 are accommodated, by way of example, on a left-hand side of a switch cabinet 36 which assumes the task of providing a water-resistant enclosure. The switch cabinet 36 may as such satisfy all of the above-identified standards for a water-resistant housing, or may be constructed as an enclosure which accommodates the aforementioned components 10, 12, 16 of the control device. For ease of illustration, the left side of the switch cabinet 36 is shown in open state and the coolant circuit for the components to be cooled is shown exaggerated. The operator terminal 38 in this case includes not only the display unit 14 and the keyboard 40 but also electronic components for the operation and control of the operator terminal 38. It is also conceivable to use a touchscreen for the display unit 14, so that the need for a separate keyboard 40 can be eliminated. Optionally, the operator terminal 38 can be equipped with an auxiliary cooling system 42 of the above-described type, especially when the electronic components for operating the operator terminal 38 generate a relatively great amount of loss heat, or when the ambient temperature during operation of the injection molding machine is relatively high. This optional cooling system 42 is indicated by broken lines in FIG. 3.

Although the water-cooled control device in accordance with the invention has been described with reference to an injection-molding machine, the present invention should not be limited thereto, as other applications which generally follow the concepts outlined here are considered to be covered by this disclosure. For example, a water-cooled control device in accordance with the invention is equally applicable for an extrusion plant or any other type of machine tool.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A plastics processing machine for making a plastic article, comprising a control device for controlling the plastics processing machine, said control device including:
a housing constructed for protection against ingress of water in compliance with IP Code;
a heat source arranged in the housing; and
a cooling system for dissipating heat generated by the heat source, said cooling system including a pump for pumping a coolant, at least one cooling element arranged inside the housing, a cooler provided outside the housing, and a coolant circuit for circulation of the coolant, said coolant circuit fluidly connecting the pump, the cooling element and the cooler with one another.

2. The plastics processing machine of claim 1 constructed in the form of an injection molding machine.

3. The plastics processing machine of claim 1, wherein the heat source is a component selected from the group consisting of a CPU unit and a display unit.

4. The plastics processing machine of claim 1, wherein the cooling element is a coolant flow plate placed upon the heat source.

5. The plastics processing machine of claim 3, further comprising a coolant flow plate for dissipating heat generated by the display unit.

6. The plastics processing machine of claim 1, further comprising an equalizer reservoir disposed upstream of the pump in the coolant circuit for coolant.

7. The plastics processing machine of claim 6, wherein the equalizer reservoir is disposed outside the housing.

8. The plastics processing machine of claim 1, further comprising a flowmeter disposed in the coolant circuit.

9. The plastics processing machine of claim 1, wherein the pump is a variable capacity pump.

10. The plastics processing machine of claim 1, wherein the coolant is water.

11. The plastics processing machine of claim 1, further comprising an operator terminal accommodating the heat source, said housing being a housing of the operator terminal.

12. The plastics processing machine of claim 3, further comprising a switch cabinet, said housing being formed at least partly by the switch cabinet, and further comprising an operator terminal positioned separate of the switch cabinet and including the display unit.

13. The plastics processing machine of claim 1, wherein the housing complies with IP code IP X1 (protection from dripping water).

14. The plastics processing machine of claim 1, wherein the housing complies with IP code IP X4 (protection from sprayed water).

15. The plastics processing machine of claim 12, wherein the coolant circuit is provided in the switch cabinet, the cooling system including a further coolant circuit for the display unit.

16. The plastics processing machine of claim 12, wherein the CPU unit is arranged in the switch cabinet, the display unit in the operator terminal and the CPU unit being connected to the coolant circuit.

17. The plastics processing machine of claim 1, wherein the cooler includes a fan.

18. The plastics processing machine of claim 1, wherein the pump is disposed within the housing.

19. The plastics processing machine of claim 1, wherein the pump is disposed outside the housing.

20. A control device for a machine tool, comprising:
a housing constructed for protection against ingress of water in compliance with IP Code;
a heat source arranged in the housing; and
a cooling system for dissipating heat generated by the heat source, said cooling system including a pump for pumping a coolant, at least one cooling element arranged inside the housing, a cooler provided outside the housing, and a coolant circuit for circulation of the coolant, said coolant circuit fluidly connecting the pump, the cooling element and the cooler with one another.
